(19) United States
(12) Patent Application Publication
(10) Pub. No.: US 2026/0212666 A1
(43) Pub. Date: Jul. 23, 2026

(54) METHOD AND SYSTEM FOR DETECTING OBJECTS IN A MARITIME OR TERRESTRIAL SCENE

(71) Applicant: HGH SYSTEMES INFRAROUGES, Igny (FR)

(72) Inventors: Axel DAVY, Palaiseau (FR); Anthony THOMAS, Massy (FR)

(21) Appl. No.: 19/136,774

(22) PCT Filed: Nov. 23, 2023
(86) PCT No.: PCT/EP2023/082793

§ 371 Date: Jun. 6, 2025

(30) Foreign Application Priority Data
Dec. 13, 2022 (FR) FR2213249

(51) Int. Cl. G06V 20/10; G06V 10/10; G06V 10/24; G06V 10/26; G06V 10/30; G06V 10/75; G06V 10/82

(52) U.S. Cl. CPC G06V 20/10; G06V 10/16; G06V 10/24; G06V 10/26; G06V 10/30; G06V 10/751; G06V 10/82

(57) ABSTRACT

A method for detecting objects in a scene is disclosed. The method includes the following steps: —acquiring a plurality of image sectors of a scene by means of at least one image sensor; —preprocessing each of the image sectors in order to correct at least one image irregularity; —constructing image segments of the scene, each image segment being constructed from at least two preprocessed image sectors; —processing the image segments by a processing algorithm according to a type of observed scene; —detecting objects in each image segment by a neural network; —reconstructing the image of the scene from the image segments.

### TECHNICAL FIELD

The present invention relates to a method for detecting objects in a maritime and/or terrestrial scene. It also relates to a system for detecting objects in a maritime and/or terrestrial scene.

### PRIOR ART

A relatively neglected topic in object detection literature is the quality of input images. The images coming out of the camera have a 14-bit dynamic range, and infrared has the peculiarity of having significant changes in intensity over the scene, but locally quite low contrasts. Passing an unprocessed image through a detection network does not give the best detection performance, and many of the processing operations known from the literature do not give good results.

In addition, infrared cameras are used in a variety of imaging applications to capture infrared images. Infrared cameras, for example, can be used for face detection, terrestrial object detection and, possibly, sea object detection.

For many practitioners in the sector, improving data processing upstream of the detection network is not mandatory, and the main focus is on the detection network. Many publications suggest very simple processing. Some publications seek to optimize image processing (e.g. for color images) to achieve the best possible detection performance.

In particular, US2014168439A1 is known from the state of the art. This document discloses systems and methods providing processing techniques and operating modes for infrared cameras for maritime applications. For example, an infrared camera system for a boat is described for monitoring the perimeter of the boat to detect a man-overboard condition. Infrared images can be processed, for example, on the basis of the man-overboard operating mode or other selectable operating modes for the infrared camera system. An alert can be provided and a spotlight and/or narrow-field-of-view camera can be directed to an area of interest if a man-overboard condition exists.

There are generally a number of drawbacks to conventional terrestrial- and maritime-based detection approaches for infrared cameras, such as the difficulty of detecting small objects.

The aim of the present invention is to resolve at least one of the cited shortcomings.

### DISCLOSURE OF THE INVENTION

This objective is achieved with a method for detecting objects in a scene, the method comprising the following steps:
acquiring a plurality of image sectors of a scene by means of at least one image sensor,
preprocessing each of the image sectors in order to correct at least one image irregularity,
constructing image segments of the scene, each image segment being constructed from at least two preprocessed image sectors,
processing the image segments by means of a processing algorithm according to a type of observed scene,
detecting objects in each image segment by means of a neural network,
reconstructing the image of the scene from said image segments.

Advantageously, the at least one image sensor may correspond to a rotating image sensor or a fixed image sensor.

Preprocessing removes dead pixels from the sector and reduces noise (photonic, electronic, fixed) in each of the image sectors.

“Image sector” is understood to mean an image portion taken from an image, in particular a so-called panoramic image.

An “image segment” is understood to mean an image constructed from at least two image sectors. Preferentially, an image segment is constructed from three image sectors. Constructing image segments rather than using image sectors for detection enables the neural network to detect objects that do not fit on a single image sector.

The aim of image segment processing is to homogenize the appearance and dynamics of the images seen by the neural network. This facilitates the network's ability to achieve maximum performance in unseen scenes. This homogeneity thus allows better network performance. In the case of object detection in a terrestrial scene, the processing also adds an image representing the difference between the current image and the sliding average of previous images. The addition of this image introduces useful temporal information for detection, particularly for small, blurred or low-contrast objects. Part of the processing for detecting objects in a terrestrial scene is adapted to make a display option of the image sensor image.

The method may further comprise the following step:
tracking of the object(s) detected by a tracking algorithm in said reconstructed scene image, the detected object(s) being associated with a tracking category.

Object tracking consists in temporally matching object detections based on movement and similarity.

Tracking the detected object may comprise matching the detected object from a detection N with the detected object from a previous detection N-I by the tracking algorithm.

The detected object(s) can be associated with at least one of the following tracking categories:
alarm,
track.

In the detection stage, the neural network proposes a target class (e.g. sailboat, human, etc.) when an object is detected. The detected object is then classified in said proposed target class. The ‘alarm’ or ‘track’ categorization comes into play during the tracking stage. A neural network detection is associated with an alarm if it does not belong to the track category. A track is formed when several alarms have been temporally matched, for example according to motion criteria, similarity criteria and a detection score. The tracks therefore correspond to tracks confirmed through matching by the tracking algorithm. The choice of the detected object's class is refined during tracking. Indeed, when a detected object is associated with the track category, the chosen class may be the one most proposed by the neural network for the object in question. Filtering of categorized objects can be set by the user.

According to one embodiment, the preprocessing step can also comprise a step for transforming the image according to a geometric transformation.

Preprocessing enables us to reconstruct, by pasting the contents of the sectors, a so-called panoramic image corresponding to a horizontal monitoring strip, with the images vertically aligned due to the property of the rotating or non-rotating image sensor(s). Since the appearance of the objects is slightly affected by deformations, correcting deformations prior to detection optimizes said detection. A straight line, for example, can become a curve when deformed. It is therefore preferable to correct the image before programming object detection.

The step of processing image segments, when a terrestrial scene is observed, can comprise the following steps, for each of the image segments:
converting the image segment according to a first, second and third conversion parameter, three output image segments being obtained and then averaged together,
determining a difference image from the image segment and a sliding average of the converted image segments,
converting the difference image according to a fourth conversion parameter,
concatenating the image segment and the converted difference image.

Processing for the detection of objects in a terrestrial scene, here called “terrestrial processing”, that is to say for the detection of terrestrial targets, gives a better image. This terrestrial processing allows implementation on very fast graphics processors. It also enhances all contrasts in the image segment, while preserving a certain local hierarchy of intensities (an object that is brighter than its surroundings will remain so in a certain neighborhood). In contrast, a classic CLAHE, depending on the parameters chosen, either enhances local contrasts or preserves a certain local hierarchy of intensities, but not both. CLAHE is a well-known technique used to enhance the local contrast of an image. Furthermore, to a certain extent, CLAHE enhances certain details in a uniform way, whereas they were not of the same contrast in the original image. This is much less the case with the terrestrial processing according to the invention. It gives an image that is quite natural and pleasant to look at for a human. It also helps the neural network to correctly detect the objects present in each image segment.

Still in the case of terrestrial targets, adding temporal information to the image provided to the neural network enhances performance in distinguishing low-contrast and/or small objects. The image provided to the neural network corresponds to an image segment processed by the processing operation.

As far as concatenation is concerned, this step produces a two-channel image. Passing a multi-channel image through the neural network optimizes detection performance.

The image segment conversion step may comprise the following steps:
determining three parameter sets,
   for each parameter set:
determining a transformation from the set of parameters,
applying the transformation to the image segment.

The step of processing the image segments, when a maritime scene is observed, can comprise the following steps, for each of the image segments:
modifying at least one image segment parameter,
applying a piecewise affine transformation on the modified image segment.

Modification of at least one image segment parameter is achieved by removing low-frequency information from the image, which is equivalent to removing a heavily blurred version of the input image. This modification causes a compression of the dynamics.

Processing for maritime scene detection, known as “maritime processing”, that is to say for maritime target detection, uses an adaptive piecewise affine transformation. As contrasts at the extremes of the original image dynamic range are of little use in maritime target detection, this transformation enables the image dynamic range to be concentrated on the essential information required for detection.

According to yet another aspect of the invention, a system for detecting objects in a maritime or terrestrial scene is proposed, the system comprising:
at least one image sensor arranged to acquire several image sectors of an observed scene,
a processing module arranged and/or programmed to apply the method according to the invention.

According to another aspect of the invention, also proposed is a computer program comprising instructions which, when the program is executed by a computer, cause the latter to implement the steps of the method according to the invention.

### DESCRIPTION OF THE FIGURES AND EMBODIMENTS

Other benefits and features shall become evident upon examining the detailed description of entirely non-limiting embodiments and implementations, and from the following enclosed drawings:

FIG. 1 is a schematic view of a system according to one embodiment of the invention.

FIG. 2a is a flowchart of the terrestrial processing according to one embodiment of the invention.

FIG. 2b is a flowchart of a terrestrial processing step according to one embodiment of the invention.

FIG. 3a is a CLAHE terrestrial image.

FIG. 3b is the first channel of a terrestrial image processed by terrestrial processing according to one embodiment of the invention.

FIG. 4a is a CLAHE maritime image.

FIG. 4b is a maritime image processed by maritime processing according to one embodiment of the invention.

These embodiments are in no way limiting, and in particular, it is possible to consider variants of the invention that comprise only a selection of the features disclosed or shown hereinafter in isolation from the other features disclosed or shown (even if that selection is isolated within a phrase comprising other features), if this selection of features is sufficient to confer a technical benefit or to differentiate the invention with respect to the prior state of the art. This selection comprises at least one preferably functional feature which lacks structural details, and/or only has a portion of the structural details if that portion is only sufficient to confer a technical benefit or to differentiate the invention with respect to the prior state of the art.

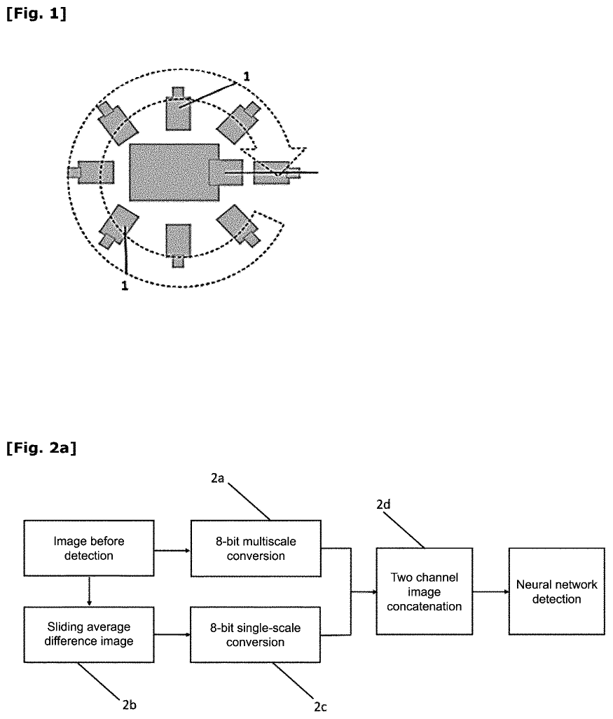

With reference to FIG. 1, a system is first described which is configured to detect objects in a maritime and/or terrestrial scene. The presented system implements the method according to the invention. The system comprises at least one rotating image sensor 1 arranged to acquire several infrared image sectors of a scene. In a first embodiment, the system comprises a single image sensor 1. The image sensor 1 is rotatable so as to acquire several sectors of the environment following a panorama. In a preferred embodiment, the rotating image sensor 1 is an infrared rotating image sensor 1. The image sensor can be rotated clockwise and counter-clockwise. The image sensor 1 can be rotated through an angle of 360 degrees.

In another embodiment, the system comprises several image sensors 1 positioned around an axis. Each image sensor 1 is then configured to acquire several sectors of the environment over a limited panorama portion. For example, each image sensor 1 can rotate through an angle of 30 degrees, depending on the number of image sensors present. The invention can be applied to other systems moving or rotating as shown.

According to other embodiments, the image sensor can correspond to one or more fixed image sensors. If a single fixed image sensor is used, this is preferentially a wide-angle image sensor. A “wide-angle” image sensor is an image sensor that acquires images with a wider viewing angle than that of a conventional image sensor.

The system also comprises a processing module (not shown in FIG. 1) arranged and/or programmed to:
preprocess each of the image sectors in order to correct at least one image irregularity,
construct image segments of the scene, each image segment being constructed from at least two preprocessed image sectors,
process the image segments by means of a processing algorithm according to a type of observed scene,
detect objects in each image segment by means of a neural network,
reconstruct the image of the scene from said image segments.

When the infrared image sensor 1 is rotated, it is configured to acquire several images at different angles of rotation. These images, taken at different times, correspond to image sectors. Depending on the model of the image sensor and its settings, this can range from a few image sectors to hundreds. At the image sensor output, the processing module is configured to preprocess these image sectors. The image sectors are then transformed by the processing module according to a geometric transformation that corrects the deformations of the image sensor. This geometric transformation positions the pixels of the image sector in a spherical frame of reference. As a result of this geometric transformation, the pixels at the left edge of an image sector correspond to photons seen by the image sensor coming from the same horizontal angle with respect to said image sensor. The same applies to the pixels on the right edge. The processing module is configured so that the relative angle of the intermediate pixels with respect to the angle corresponding to the edges of the image sector is linearly dependent on their pixel coordinate in the image. The same phenomenon is forced vertically.

With mathematical notation, let integer x and y coordinates, between 0 and w−1 and 0 and h−1, respectively, correspond to the coordinates of a pixel in the image of width w and height h, then the horizontal angle θ verifies at each pixel that:

$$θ ( x , y ) = \frac{x}{w - 1} ( θ ( w - 1 , 0 ) - θ ( 0 , 0 ) ) + θ ( 0 , 0 )$$

Similarly, the vertical angle φ verifies at each pixel that:

$$φ ( x , y ) = \frac{y}{h - 1} ( φ ( 0 , h - 1 ) - φ ( 0 , 0 ) ) + φ ( 0 , 0 )$$

Once the image sector preprocessing step has been completed, the processing module is configured to construct image segments. Each image segment is constructed from three image sectors, ideally without overlap except for the last sector if the number of image sectors is not a multiple of three. In some embodiments, an image segment is constructed from three image sectors with partial overlap between each image sector. A partial overlap is one wherein the overlap of image sectors is less than a total overlap. Generally speaking, image segment sizes can correspond to 2160×1280 (Spynel X), 1536×640 (Spynel S) or 1920×512 (Spynel M).

In another embodiment, the processing module can be configured to construct, from the acquired image sectors, a panoramic image of the surrounding scene. In this case, the processing module is then configured to divide said panoramic image into image segments according to the invention.

The processing module is then configured to process the image segments separately via a processing algorithm depending on the type of scene observed by the image sensor. Three types of scenes can be observed: a maritime scene, a terrestrial scene, a maritime and terrestrial scene. The image segments are processed as images for the “maritime” and “terrestrial” processing algorithms. The processing module is therefore configured to process image segments differently depending on the type of scene observed.

The processing module is configured to use so-called “maritime” processing when a maritime scene or scene portion is observed by the image sensor.

The processing module is configured to use so-called “terrestrial” processing when a terrestrial scene or scene portion is observed by the image sensor.

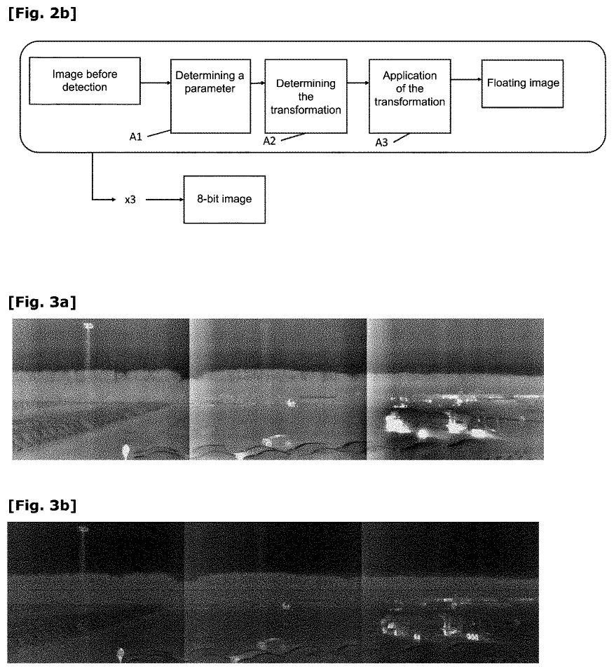

FIG. 2a shows a flowchart of the processing applied by the processing module when a terrestrial scene is observed according to the invention.

Terrestrial processing is broken down into several stages. The pre-detection image, that is to say the input image segment, is converted 2a using multi-scale conversion so as to obtain an eight-bit image. For each image segment, the processing module is configured to:
convert 2a the image segment according to a first, second and third conversion parameter, three output image segments being obtained and then averaged together,
determine 2b a difference image from the image segment and a sliding average of the converted image segments,
convert 2c the difference image according to a fourth conversion parameter,
concatenate 2d the image segment and the converted difference image. Step 2a is divided into sub-steps as shown in FIG. 2b.

The processing module is configured to determine A1 three parameter sets, and for each parameter set:
determine a transformation A2 from the parameter set,
apply the transformation A3 to the image segment.

The processing module is then configured to calculate (step A1 in FIG. 2b), for an input image, that is to say an image segment, local histograms over three local neighborhood sizes. The three sizes can correspond to the following sizes, for example: size 1: 256×256, size 2: 128×64, size 3: 16×16. A local neighborhood size corresponds to a conversion parameter. Here, there are therefore three defined conversion parameters.

For the two largest local neighborhood sizes, these histograms are used by the processing module to retrieve predetermined quantiles (step A2 in FIG. 2b). In the case of the present invention, the processing module is configured to recover the minimum quantile, the maximum quantile and quantiles at 1% and 99%. The processing module is then configured to apply a piecewise affine transformation to each neighborhood (step A3 in FIG. 2b). That is to say that the processing module is configured to linearly project, onto the interval [0, 25.5], the pixels between the minimum image value and the 1% quantile of the image. The processing module is also configured to linearly project the values contained between the 1% quantile and the 99% quantile onto [25.5, 229.5] and the remainder onto [229.5, 255]. The processing module, in the case of the smaller size, is configured to perform a linear transformation from minimum to maximum to [0, 255].

A floating-point image, that is to say, an image encoded with floating-point numbers, is output for each local neighborhood size. These images are then averaged for the three local neighborhood sizes, and converted to eight-bit integers. The processing module is then configured to calculate a sliding average difference image (step 2b in FIG. 2a) at this image position prior to detection. To calculate the difference image, the processing module subtracts the sliding average of the input images (that is to say the image segments prior to detection) from the input image segment (factor 0.95).

The processing module is then configured to convert (2c in FIG. 2a) the difference image into the sliding average according to a single-scale conversion. In other words, the conversion operates in the same way as explained above, but with a single neighborhood size. The processing module is configured to calculate local histograms over a local neighborhood size. Size 2 is used here. Size 2 corresponds to the fourth conversion parameter which, in this embodiment, is similar to one of the first three conversion parameters defined above. Once the image segment has been processed in this way, the processing module is configured to round pixel values to integers. The processing module can also be configured to then multiply the signal by a constant.

The “current image” and “difference image” duo produced is concatenated (step 2d in FIG. 2a) by the processing module and then passed on to the neural network for detection. “Current image” is understood to mean the most recent image segment available, that is to say the input image segment for processing. A subtraction of one hundred twenty-seven is performed before supplying the image to the neural network. In other words, the processing module is configured to center the signal, here by subtracting one hundred twenty-seven.

FIG. 3a shows a CLAHE terrestrial image, and FIG. 3b shows the first channel of the terrestrial image of FIG. 3a processed by the so-called terrestrial processing according to the invention.

The so-called “maritime” processing is configured to remove low-frequency information from the image, or image segment, by removing a heavily blurred version of the input image, the input image having a fourteen-bit encoding. The processing module is then configured to apply a piecewise affine transformation using the image quantiles. More specifically, the processing module is configured, with the following proposed parameters, to linearly project, onto the interval [0, 25.5], the pixels between the minimum image value and the 1% quantile of the image. The processing module is also configured to linearly project the values contained between the 1% quantile and the 99% quantile onto [25.5, 229.5] and the remainder onto [229.5, 255]. Once the image segment has been processed in this way, the processing module is configured to round pixel values to integers and subtract one hundred twenty-seven before providing the image to the neural network. This projection step corresponds to normalization before executing a neural network. In other words, the processing module is configured to center the signal, here by subtracting one hundred twenty-seven. The processing module can also be configured to then multiply the signal by a constant.

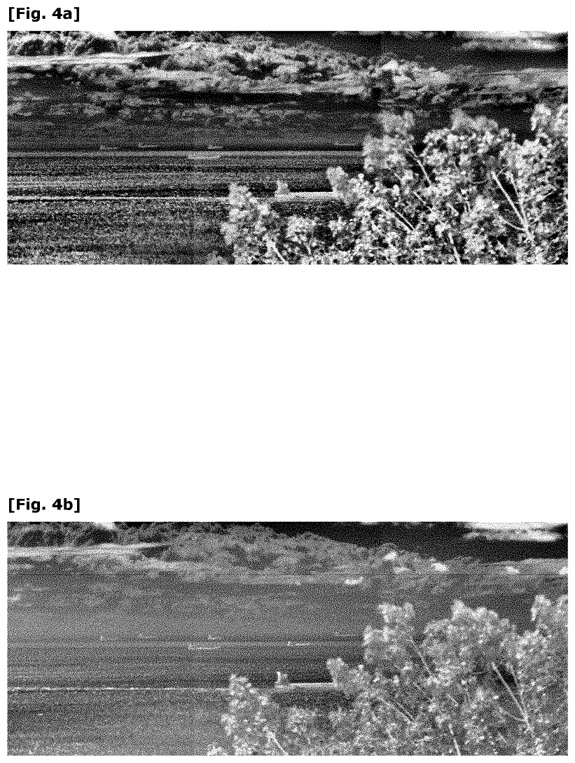

FIG. 4a shows a CLAHE maritime image, and FIG. 4b shows the maritime image of FIG. 4a processed by the so-called maritime processing according to the invention.

In an embodiment where both a maritime and terrestrial scene is observed by the image sensor, both maritime and terrestrial processing can be used by the processing module 2.

When the image segments have been processed according to the type of scene observed, the processing module is configured to detect one or more objects in each processed image segment via a neural network.

For the neural network, a network architecture based on TTFNet (Training-Time-Friendly Network) is used. In other embodiments, any other type of compatible network can be used. The neural network is configured to return a table of, for example, the hundred highest score detections. This eliminates detections below a user-defined threshold. The processing module can also be configured to use an additional algorithm to filter out duplicate detections. In a particular embodiment, the additional algorithm is a “non-maximum suppression” (NMS) algorithm. The detection step then detects whether or not objects are present in each image segment.

The processing module is then configured to construct a panoramic image of the scene from the image segments processed by the neural network. Finally, the processing module is configured to track said detected objects of the reconstructed scene via a tracking algorithm in said image, the detected object(s) being associated with a tracking category.

The detections are matched with previous detections via the tracking algorithm. The detected objects are then classified into one of the following classes: alarm or track. The objects are then filtered according to user-defined rules, and forwarded to the user. The panoramic image can be displayed to the user, and the detected objects can be overlaid on this panoramic image, for example.

Typically at least one of the means of the device according to the invention previously described, preferably each of the means of the device according to the invention previously described, is a technical means.

Typically, each means of the device according to the invention previously disclosed comprises at least one computer, a central processing or computing unit, an analog electronic circuit (preferably dedicated), a digital electronic circuit (preferably dedicated), and/or a microprocessor (preferably dedicated), and/or software means.

Of course, the invention is not limited to the examples just described, and many adjustments can be made to these examples without going beyond the scope of the invention.

Of course, the various embodiments, features, forms and variants of the invention may be combined with each other in various combinations as long as they are not incompatible or exclusive of each other. In particular, all the embodiments and variants described above can be combined with one another.

1. A method for detecting objects in a scene, the method comprising the following steps:
acquiring a plurality of image sectors of a scene by means of at least one image sensor;
preprocessing each of the image sectors in order to correct at least one image irregularity;
constructing image segments of the scene, each image segment being constructed from at least two preprocessed image sectors;
processing the image segments by means of a processing algorithm according to a type of observed scene;
detecting objects in each image segment by means of a neural network; and
reconstructing the image of the scene from said image segments.

2. The method according to claim 1, wherein the at least one image sensor corresponds to a rotating image sensor or a fixed image sensor.

3. The method according to claim 1, wherein the method also comprises the following step:
tracking of the object(s) detected by a tracking algorithm in said reconstructed scene image, the detected object(s) being associated with a tracking category.

4. The method according to claim 3, wherein tracking the detected object comprises matching the detected object from a detection N with the detected object from a previous detection N−1 by the tracking algorithm.

5. The method according to claim 1, wherein the detected object(s) are associated with at least one of the following tracking categories:
alarm,
track.

6. The method according to claim 1, wherein the preprocessing step also comprises a step for transforming the image according to a geometric transformation.

7. The method according to claim 1, wherein the step of processing image segments, when a terrestrial scene is observed, comprises the following steps, for each of the image segments:
converting the image segment according to a first, second and third conversion parameter, three output image segments being obtained and then averaged together;
determining a difference image from the image segment and a sliding average of the converted image segments;
converting the difference image according to a fourth conversion parameter; and
concatenating the image segment and the converted difference image.

8. The method according to claim 7, wherein the image segment conversion step comprises the following steps:
determining three parameter sets; and
for each parameter set:
determining a transformation from the parameter set; and
applying the transformation to the image segment.

9. The method according to claim 1, wherein the step of processing image segments, when a maritime scene is observed, comprises the following steps, for each of the image segments:
modifying at least one image segment parameter; and
applying a piecewise affine transformation on the modified image segment.

10. A system for detecting objects in a maritime or terrestrial scene, the system comprising:
at least one image sensor arranged to acquire several image sectors of an observed scene; and
a processing module arranged and/or programmed to apply the method according to claim 1.

11. A computer program product comprising instructions which, when the program is executed by a computer, cause the latter to implement the steps of the method according to claim 1.
